(19) United States
(12) Patent Application Publication
(10) Pub. No.: US 2017/0120273 A1
(43) Pub. Date: May 4, 2017

(54) LIQUID DISPENSING BOTTLE

(71) Applicant: Dana Michele, LLC, New York, NY (US)

(72) Inventor: Dana M. GOLDSTEIN, New York, NY (US)

(21) Appl. No.: 14/931,010

(22) Filed: Nov. 3, 2015

(51) Int. Cl. B05B 11/00; B65D 1/02; B65D 23/10; B65D 21/02

(52) U.S. Cl. CPC B05B 11/0037; B65D 21/0228; B65D 1/0223; B65D 23/102; B05B 11/0089

(57) ABSTRACT

A container for dispensing a liquid has a housing adapted to hold the liquid with an open upper end and a removable cap mateable with the open end. The housing exterior has a series of vertically spaced recesses that are located to align with fingers of an individual's hand gripping the container. The recesses accept interchangeable inserts that provide a gripping surface for the finger aligned with the recess. The container be constructed with inner and outer walls, the outer wall having apertures for the recesses, while the inner wall provides back surfaces for the recesses. The recesses may be of different sizes, but each is constructed to accept a common-sized insert, which is positioned between the finer and outer walls. The container may be provided with a spray cap having multiple spray exit apertures.

The present invention relates to a liquid dispensing bottle and in particular to such a bottle customizable to the desires of the user and having an improved dispensing feature.

### BACKGROUND OF THE INVENTION

Lightweight, reusable bottles for water and other liquids are well known and are commonly used by athletes and others. Typical bottles are cylindrical in shape, with a removable cap incorporating a valve to allow the contained liquid to be dispensed. A standard, cylindrically shaped bottle may be difficult to hold, especially when the hand of the user is sweaty. In addition, the conventional water bottle normally dispenses water in a single stream and is of a relatively drab appearance.

### SUMMARY OF THE INVENTION

In accordance with the present invention, a water- or other liquid-dispensing container comprises a body and cap adapted to hold a liquid and dispense the liquid through the cap. The container body is provided with a series of receptacles, preferably spaced to correspond with the position of the fingers of the user about the bottle when gripped. The receptacles accept mating inserts which both are of a composition to improve the gripability of the bottle and to provide an opportunity for the user to provide some measure of decoration and identification to the bottle. The inserts are interchangeable allowing them to be replaced and varied as desired. The bottle may also include a cap having a valve and spout assembly which directs a shower of liquid outwardly from the bottle, as opposed to a single stream, allowing for greater functionality of the bottle.

### BRIEF DESCRIPTION OF THE DRAWINGS

A fuller understanding of the present invention will be accomplished upon review of the following detailed description of an illustrative embodiment of the invention, when taken in conjunction with the annexed drawings wherein:

FIG. 1 is a perspective view of the bottle body of the invention with the inserts to be inserted therein;

FIG. 2 is a perspective view of the bottle body with inserted inserts;

FIG. 3 is a sectional view of the bottle body;

FIG. 4 is a front elevation view of a typical insert;

FIG. 5 is a top plan view of an insert;

FIG. 6 is a sectional view of an insert taken along line 6-6 of FIG. 5;

FIG. 7 is a perspective view of the cap of the invention;

FIG. 8 is an elevation view of the invention with the cap and inserts in place;

FIG. 9 is a perspective view of an segmented bottle construction;

FIG. 10 is a sectional view along the cut line presented in FIG. 3, detailing a recess;

FIGS. 11 and 11a are section views of FIG. 9 showing an insert in place in the recess of FIG. 10 and in an alternative outer wall construction; and

FIGS. 12a and 12b are sectional views of the cap for the bottle.

### DETAILED DESCRIPTION OF THE INVENTION

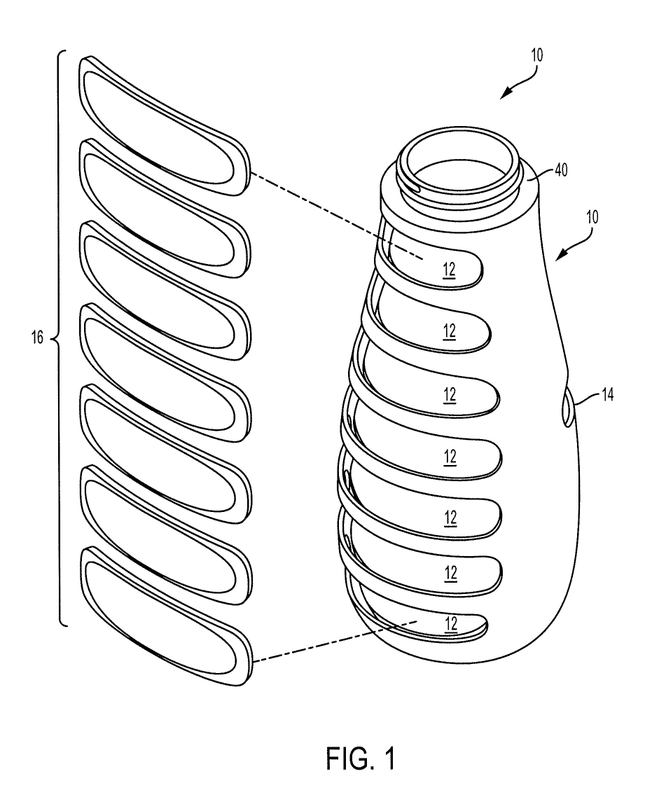

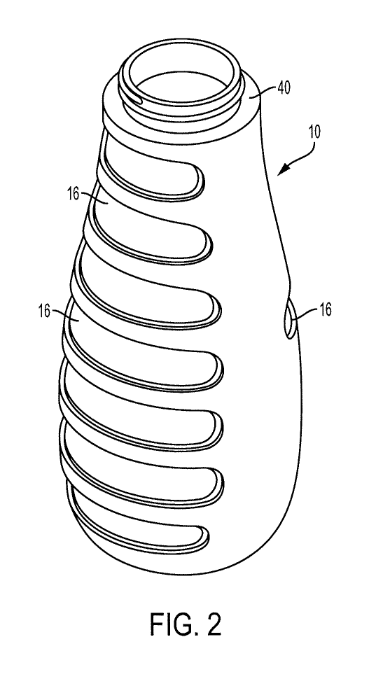

With initial reference to FIGS. 1 and 2, liquid-dispensing bottle container 10 may be manufactured of any appropriate material, typically a plastic composition, as known in the art. To provide the required flexibility to allow squeezing of the container for dispensation of its contents, a low density polyethylene may be employed. The bottle may be of any particular shape, but, as shown in the drawings, a preferred design is embodied in a bulbous shape, widening gently downward from a narrow neck portion. Recesses are provided about the periphery of the bottle to accept a series of inserts. A first series of recesses 12 may be aligned vertically in the container, with a second recess 14 positioned in the container in an opposed position to the recesses 12. The recesses 12 are preferably spaced to generally conform to the spacing of a user's fingers when gripping the container, and are of a width/height compatible with average finger size, which may be on the order of an inch. The opposed second recess 14 is preferably positioned at a location to accommodate the thumb when the user's fingers are aligned with corresponding recesses 12. A series of inserts 16 are provided to be mountable within the recesses 12 and recess 14 to provide a gripping surface for the fingers and thumb, while at the same time being interchangeable to allow the user to customize the grips and thus the appearance of the container to his or her liking. As shown, a series of inserts are provided for mounting in the recesses 12. While the recesses 12 may be of varying lengths, the inserts 16 are preferably all of the same size, allowing them to be interchanged between the recesses. The size of a recess determines what portion of the insert is exposed, thus providing an illusion that inserted inserts are of different sizes.

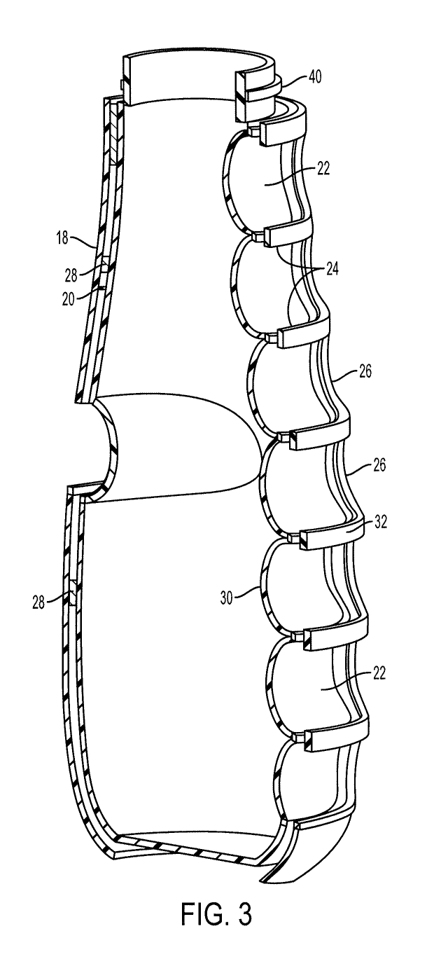

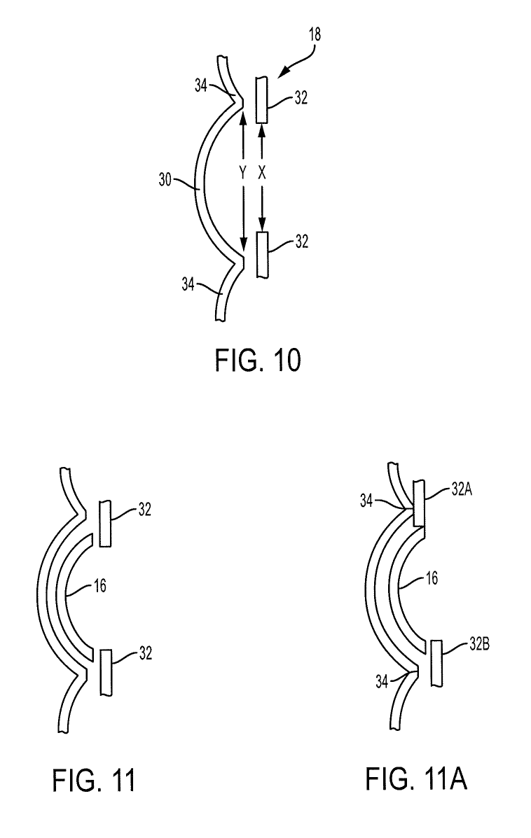

With further reference to FIG. 3, bottle container 10 may be constructed with outer and inner walls 18, 20, with the installed inserts 16 lying therebetween. Outer wall 18 is provided with a series of apertures 22, the edges of which define the peripheral front edges of the recesses. The apertures may have parallel horizontally-extending upper and lower sides 24, bounded at their ends by curved return portions 26. The container inner wall 20 is solid, providing the actual receptacle for the liquid to be held by the bottle, and provides bottom/back surfaces for the recesses. As best seen in FIGS. 3 and 10, inner wall 20 is formed with concave portions 30, each aligned with an aperture in outer wall 18 and having a width or height “y”. The aligned apertures 22 in the outer wall 18 have a smaller height “x”, whereby the horizontal edge portions 32 of the outer wall in front of the top and bottom edges 34 of the concavities 30 in the inner wall form retaining shoulders for the inserts. The outer and inner walls are connected together at spaced locations about the circumference of the container by spacers 28. The walls may also be joined together by spacers or a filler between their respective bottoms. Alternatively the bottle may be constructed with a single wall, the bottom/back surfaces for recesses being molded or otherwise formed in the single wall. While the apertures in the outer wall are shown as being generally rectangular, they may be of other shapes, and may have wavy or serrated wall edge designs.

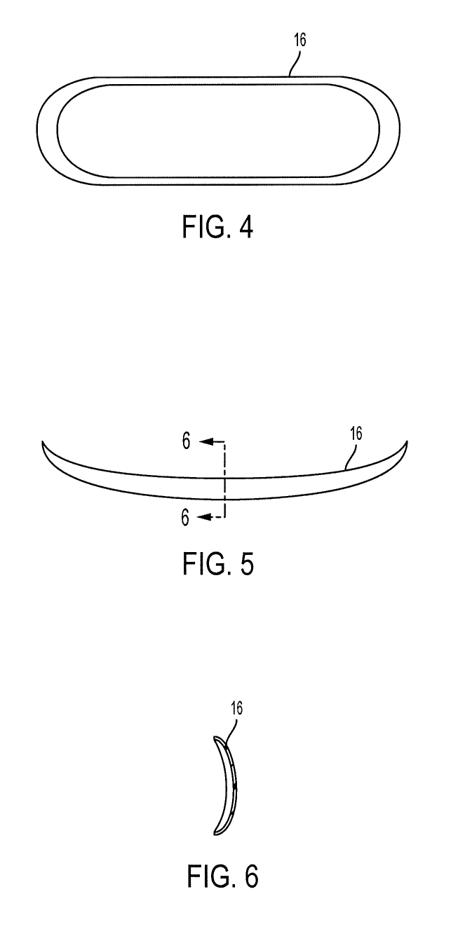

The inserts 16 are detailed in FIGS. 4-6. Each of the inserts may be configured to be of a generally rectangular shape as seen in elevation, FIG. 4, but with a curvature in plan, with parallel upper and lower side edges joined by arcuate ends. Alternatively, they may be flat. The inserts are formed of a flexible plastic material, which allows them to conform to the curvature of the recesses in the container into which they are to be inserted. The lengths of the inserts are preferably identical; depending on the size of the recess 12, 14 into which an insert is placed, more or less of the insert will be visible in the recess. FIG. 11 details an insert 16 in place, the outer wall edges 32 retaining the insert in place. In addition, as depicted in FIG. 11a, The apertures may be formed such that the top edge 32A aligns with the an edge 34 of the concavity, such that the insert does not rest behind that front wall, the insert being retained within the aperture at the ends and by the lower edge 32B, allowing easier insertion of the insert into the aperture.

The inserts may be of different colors, and/or have wording and/or decorative indicia on their front faces which will be seen when the inserts are installed on the container. Due to their flexibility, the inserts can be manipulated to be inserted into the recesses, being retained in the concavities 30 of the inner wall 20 by the shoulders 32 of the outer wall 18. The concavities 30 are of a length greater than the length of the inserts, allowing the inserts to be slid along the concavities to position them as needed and to, for example, expose an end of an insert for gripping for removal.

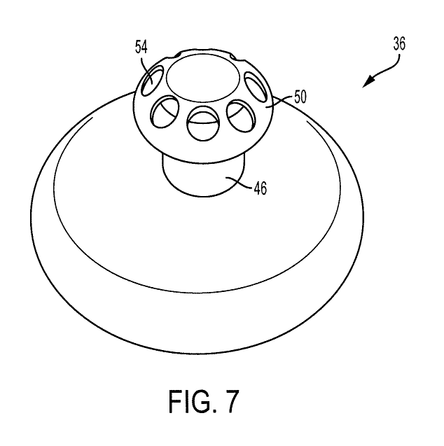

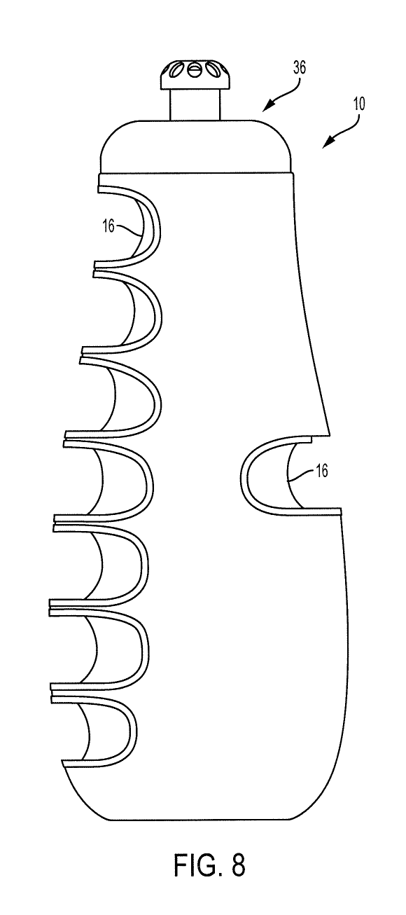

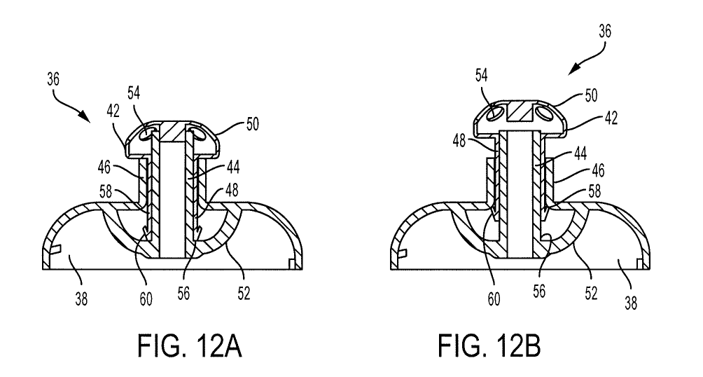

The container may be provided with a cap of conventional construction, having a spout as known in the art. Preferably, however, the cap may be configured as shown, for example, In FIG. 7 and detailed in FIGS. 12a and b. As shown therein, cap unit 36 is provided with an inner thread 38 to mate with the exterior thread 40 on the neck of bottle 10. Exit pipe 44, supported by support 52, extends upwardly concentrically within molded cap neck 46 and spaced from the neck's inner surface, and provides an exitway for the liquid in the container. Poppet valve/spray head unit 42 comprises hollow stem 48 leading to spray head 50, is tightly supported for vertical travel within the cylindrical space between the cap neck and the exit pipe 44. Spray head 50 is provided with a plurality of orifices 54 through which the bottle contents can exit in a shower-like spray about the periphery of the cap and poppet. The orifices may be eight in number.

The extent of vertical travel of the poppet is controlled by the shoulders 60 formed at the lower end of the poppet. At the lower end of travel the shoulders engage shaft support 52 at location 56. At the same time the upper end of the exit pipe engages the inner surface of spray head 50, closing off the exit pipe in a liquid-tight seal with the spray head. When the poppet is manually lifted from the lower position, the shoulders engage the lower end of neck 46 at 58, providing a stop for upward travel. At the same time the inner surface of the spray head rises upwardly, away from the exit pipe, providing a passageway for the liquid in the container through the exit pipe and into the spray head for dispensation through the orifices, providing a shower-like spray. Manually depressing the spay head again closes off the exit pipe, sealing the container contents.

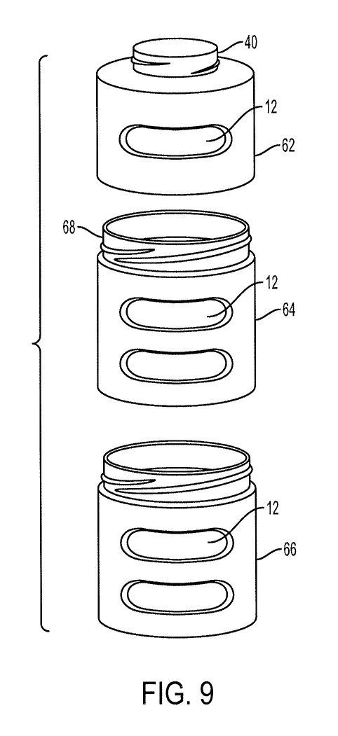

Although the invention has been described with reference to a particular embodiment, this description is not meant to be construed in a limiting sense. Various modifications of the disclosed embodiments as well as alternative embodiments of the invention will become apparent to persons skilled in the art, and the following claims are intended to cover any such modifications or embodiments that fall within the scope of the invention. For example, FIG. 9 depicts a construction in which the bottle is constructed of a series of individual segments or portions 62, 64, 66. Each of the portions form an individual cup or container with a bottom wall, and portions 64, 66 have a upper threaded section 68 adapted to mate with a complementary internal thread (not shown) on the above adjacent portion. Portions 64, 66 may have open tops, and may be provided with mating covers to seal the portions when separated from the others. Such a construction allows for different contents to be placed in the portions, and may further allow for the stacking of portions to create constructions of different sizes and/or overall shapes. In addition, the bottle may be made of a rigid material. In such a situation a spray head may be omitted, while the finger recesses remain to provide an improved gripping functionality.

I claim:

1. A container for dispensing a liquid, comprising a housing adapted to hold the liquid having an open upper end and a removable cap mateable with the open end, the housing having a series of recesses.

2. The container of claim 1 wherein the recesses are spaced vertically located to align with fingers of an individual's hand gripping the container, each of the recesses being adapted and constructed to accept an interchangeable insert providing a gripping surface for the finger aligned with the recess.

3. The container of claim 2 further comprising interchangeable inserts accepted in the recesses.

4. The container of claim 3, wherein the housing has a further recess in an opposed position to the series of recesses located to align with a thumb of the individual's hand gripping the container, the further recess being adapted and constructed to accept an interchangeable insert providing a gripping surface for the thumb.

5. The container of claim 1 wherein a recess comprise a shouldered access aperture and a back wall, an insert being retained between the shoulders and the back wall.

6. The container of claim 5 wherein the housing comprises a first outer wall and a second inner wall spaced from the outer wall, the outer wall having the shouldered apertures and the inner wall having the recess back walls.

7. The container of claim 6 wherein the outer and inner walls are joined together at spaced locations by spacers extending therebetween.

8. The container of claim 2 wherein the recesses are of differing lengths and the interchangeable inserts are of a consistent length greater than the greatest length of the recesses.

9. The container of claim 1 wherein the cap includes a poppet spray head having a plurality of orifices for dispensing a liquid from the container.

10. The container of claim 9 wherein the container has an exit pipe in fluid connection with the orifices when the spray head is in a first position and in a sealed orientation with respect to the orifices when the spray head is in a second position.

11. The container of claim 10, the spray head having a stem surrounding the exit pipe for vertical travel between the first and second positions.

12. A container for dispensing liquid, comprising a plurality of individual housings adapted to hold a liquid each having an open upper end, the housings removably connectable to each other to form an upstanding stack; a removable cap mateable with the open end of a topmost of the housings, at least one of the housings having a recess located to align with a finger of an individual's hand gripping the container, the recess being adapted and constructed to accept an interchangeable insert providing a gripping surface for the finger aligned with the recess.

13. The container of claim 12 wherein the individual housings are connectable by means of threaded connections on the housings.
